(19) United States
(12) Patent Application Publication
(10) Pub. No.: US 2015/0071102 A1
(43) Pub. Date: Mar. 12, 2015

(54) MOTION CLASSIFICATION USING A COMBINATION OF LOW-POWER SENSOR DATA AND MODEM INFORMATION

(71) Applicant: QUALCOMM Incorporated, San Diego, CA (US)

(72) Inventors: Shankar SADASIVAM, San Diego, CA (US); Haksoo CHOI, Los Angeles, CA (US); Jinwon LEE, San Diego, CA (US)

(21) Appl. No.: 14/479,167

(22) Filed: Sep. 5, 2014

Related U.S. Application Data
(60) Provisional application No. 61/875,485, filed on Sep. 9, 2013.

(51) Int. Cl. H04W 4/02

(52) U.S. Cl. CPC H04W 4/026; H04W 4/027
USPC 370/252

(57) ABSTRACT

Disclosed is an apparatus and method for motion classification using a combination of low-power sensor data and modem information. In one embodiment, data received from at least one low-power sensor is collected. Information regarding cellular network signals is collected from a modem. A speed estimate is determined based on the information regarding cellular network signals. A motion context classification is then determined based on a combination of the collected data received from the at least one low-power sensor and the speed estimate.

### CROSS-REFERENCE TO RELATED APPLICATIONS

This application is based upon and claims the benefit of priority of prior patent application number 61/875,485 entitled MOTION CLASSIFICATION USING A COMBINATION OF ACCELEROMETER DATA AND MODEM INFORMATION filed on Sep. 9, 2013.

### FIELD

The subject matter disclosed herein relates generally to motion and activity classification using sensors and modems on a mobile device.

### BACKGROUND

Classifying physical motion contexts of a mobile device is useful for various applications. Such applications may include motion-aided geo-fencing, motion-aided Wi-Fi scan optimization, distracted pedestrian detection, health monitoring, etc. Common classifications may include walking, running, biking, driving, fiddling, and being stationary, etc.

For example, determining whether a user holding a mobile device is driving is of special interest because it may be desirable to temporarily disable certain functions of the mobile device, e.g., texting, while the user is driving so that the user does not get distracted from driving by operating the mobile device.

Distinguishing between a stationary classification and a classification indicating traveling in a vehicle is also useful for Wi-Fi scan optimization. For example, when a mobile device is stationary, it is unlikely that new scans will give new information, and when the device is being moved in a vehicle, connections to stationary Wi-Fi access points are unlikely to be successful.

Motion contexts of a mobile device can be established through gathering and processing data received from sensors and other devices embedded in a mobile device. Motion context classification based on data received from an accelerometer embedded in a mobile device is well known in the art. An accelerometer is a low-power sensor capable of outputting data representing a current acceleration. A user's physical motion is transferred to a mobile device and the accelerometer embedded therein by either direct or indirect physical connection, such as by the user holding the mobile device in hand, or by the user keeping the mobile device in a pocket. Motion context classification based on or assisted by measurement data gathered from other low-power sensors such as gyroscopes, magnetometers, ambient light sensors (ALS's), etc., is also known in the art. Unfortunately, data gathered from low-power sensors is often insufficient for accurate motion context classification. Additionally, some higher power sensors such as an on-board microphone or camera can assist with low-power motion classification if the sampling rates are managed well to fit within desired power budgets. For the purposes of this application, we will treat all these as low-power sensors, with the understanding that the sensors' sampling rates may be different for realizing a fixed low-power target.

### SUMMARY

Disclosed is a method of motion classification using a combination of low-power sensor data and modem information comprising: collecting data received from at least one low-power sensor; collecting information regarding cellular network signals from a modem; determining a speed estimate based on the information regarding cellular network signals; and determining a motion context classification based on a combination of the data received from the at least one low-power sensor and the speed estimate.

Further disclosed is a non-transitory computer-readable medium including code which, when executed by a processor, causes the processor to perform a method comprising: collecting data received from at least one low-power sensor; collecting information regarding cellular network signals from a modem; determining a speed estimate based on the information regarding cellular network signals; and determining a motion context classification based on a combination of the data received from the at least one low-power sensor and the speed estimate.

Further disclosed is an apparatus for motion classification using a combination of low-power sensor data and modem information comprising: a memory; and a processor configured to: collect data received from at least one low-power sensor; collect information regarding cellular network signals from a modem; determine a speed estimate based on the information regarding cellular network signals; and determine a motion context classification based on a combination of the data received from the at least one low-power sensor and the speed estimate.

Further disclosed is an apparatus for motion classification using a combination of low-power sensor data and modem information comprising: means for collecting data received from at least one low-power sensor; means for collecting information regarding cellular network signals from a modem; means for determining a speed estimate based on the information regarding cellular network signals; and means for determining a motion context classification based on a combination of the data received from the at least one low-power sensor and the speed estimate.

### BRIEF DESCRIPTION OF THE DRAWINGS

FIG. 1 is a block diagram of a system in which aspects of the invention may be practiced;

FIG. 2 is a flow diagram of one embodiment of a method of motion classification operative on a data processing system using a combination of low-power sensor data and modem information;

FIG. 3A is a histogram of the standard deviation of RSSIs of a serving cell tower observed on a stationary data processing system. FIG. 3B is a histogram of the standard deviation of RSSIs of serving cell towers observed on a data processing system being moved at a non-negligible speed; and

FIG. 4 is a simplified block diagram of a device that utilizes a low-power sensor and a modem to implement embodiments of the invention.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

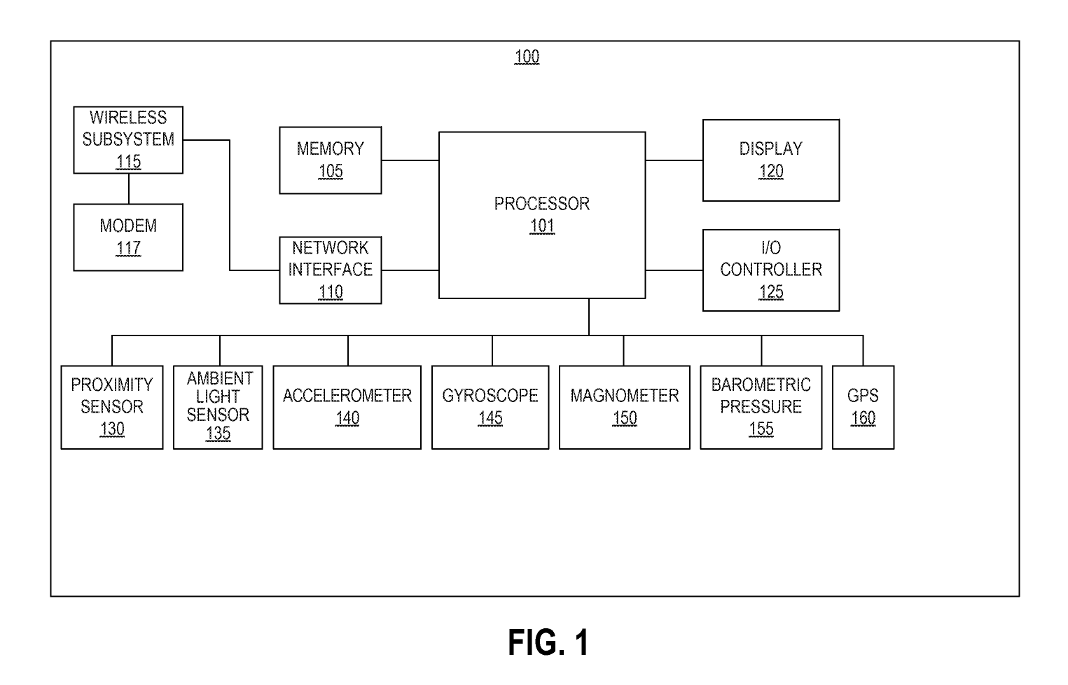

FIG. 1 is block diagram illustrating an exemplary device 100 in which embodiments of the invention may be practiced. The system may be a device (e.g., the device 100), which may include one or more processors 101, a memory 105, I/O controller 125, and network interface 110. Device 100 may also include a number of device sensors coupled to one or more buses or signal lines further coupled to the processor 101. It should be appreciated that device 100 may also include a display 120, a user interface (e.g., keyboard, touch-screen, or similar devices), a power device (e.g., a battery), as well as other components typically associated with electronic devices. In some embodiments, device 100 may be a mobile device. Network interface 110 may also be coupled to a number of wireless subsystems 115 (e.g., Bluetooth, Wi-Fi, Cellular, or other networks) to transmit and receive data streams through a wireless link to/from a wireless network, or may be a wired interface for direct connection to networks (e.g., the Internet, Ethernet, or other wireless systems). When a Cellular subsystem is present, a modem 117 is included to modulate and demodulate data streams transmitted to and received from a Cellular network. Thus, device 100 may be a: mobile device, wireless device, cell phone, personal digital assistant, mobile computer, tablet, personal computer, laptop computer, or any type of device that has processing capabilities and that is mobile.

Device 100 may include sensors such as a proximity sensor 130, ambient light sensor (ALS) 135, accelerometer 140, gyroscope 145, magnetometer 150, barometric pressure sensor 155, and/or Global Positioning Sensor (GPS) 160.

Memory 105 may be coupled to processor 101 to store instructions for execution by processor 101. In some embodiments, memory 105 is non-transitory. Memory 105 may also store one or more models or modules to implement embodiments described below. Memory 105 may also store data from integrated or external sensors.

It should be appreciated that embodiments of the invention as will be hereinafter described may be implemented through the execution of instructions, for example as stored in the memory 105 or other element, by processor 101 of device 100 and/or other circuitry of device and/or other devices. Particularly, circuitry of device, including but not limited to processor 101, may operate under the control of a program, routine, or the execution of instructions to execute methods or processes in accordance with embodiments of the invention. For example, such a program may be implemented in firmware or software (e.g. stored in memory 105 and/or other locations) and may be implemented by processors, such as processor 101, and/or other circuitry of device. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by device 100 itself and/or some or all of the functions, engines or modules described herein may be performed by another system connected through I/O controller 125 or network interface 110 (wirelessly or wired) to device. Thus, some and/or all of the functions may be performed by another device or system and the results or intermediate calculations may be transferred back to device 100. In some embodiments, such other device may comprise a server configured to process information in real time or near real time.

Motion context classification based solely on data gathered from one or more low-power sensors may be inaccurate and may generate false results because some different motion contexts exhibit similar characteristics measured by the low-power sensors. For example, a stationary mobile device and a mobile device being carried in a motor vehicle traveling at a constant speed on a smooth road both experience zero or negligible acceleration. Therefore, accelerometer data alone may be insufficient to distinguish between the two motion contexts. Motion context classification based solely on low-power sensor data is prone to generating false positives and false negatives under such scenarios.

To assist classifying motion contexts by better distinguishing between a stationary mobile device and a mobile device being moved at a constant speed in a vehicle, for example, speed information regarding the mobile device is useful. The Global Positioning System (GPS) is capable of providing mobile devices equipped with GPS receivers with speed information. However, given the current state of technology, GPS receivers consume a significant amount of power and are therefore not suitable for always-on operations.

Doppler-based methods of speed estimation implemented with cellular network modems are also well known in the art. These methods, however, are available only when the modem is in a voice-call mode. Further, they consume a significant amount of power and are therefore not suitable for always-on operations, either.

A method described herein provides a probabilistic speed estimate based on information continuously maintained by an operating cellular network modem. The information may include received signal strength indicators (RSSIs) and/or IDs of neighboring cell towers and/or serving cell tower(s). Generally speaking, information and/or measurements related to cellular network signals changes faster and/or more frequently as the speed at which the device 100 moves increases. Because the method primarily utilizes information that is already available all the time and makes no extra measurements, it is power efficient and suitable for always-on operations.

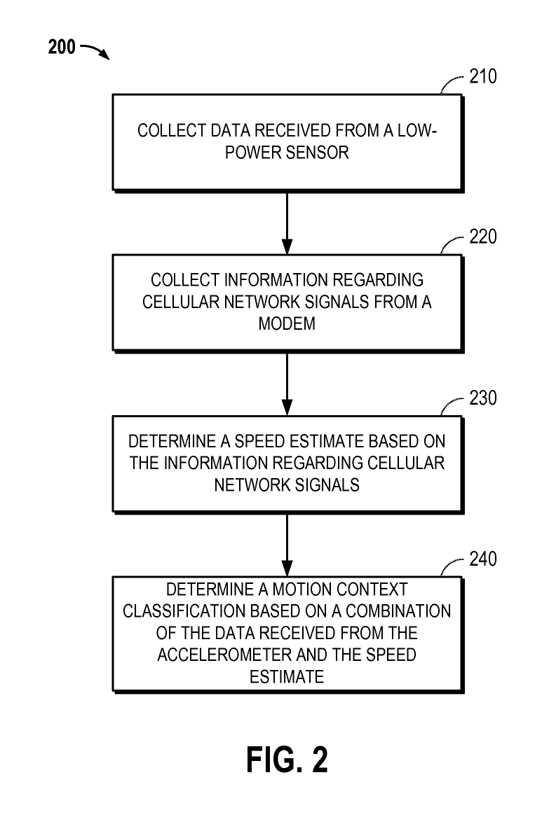

FIG. 2 is a flow diagram of one embodiment of a method 200 of motion classification operative on an example device 100 using a combination of low-power sensor data and modem information. At operation 210, data received from at least one low-power sensor is collected. The at least one low-power sensor may be, for example, an accelerometer 140, a gyroscope 145, a magnetometer 150, or an ambient light sensor (ALS) 135, etc. At next operation 220, information regarding cellular network signals is collected from modem 117. The information regarding cellular network signals may be any combination of RSSIs and/or IDs of neighboring cell towers and/or serving cell tower(s). In one embodiment described herein, only RSSIs of serving cell tower(s) are used. In an alternative embodiment, information regarding the identities of the serving cell tower(s) is used. In other words, the higher the speed, the higher the rate of change of the identities of the serving tower(s). In yet another embodiment, information regarding the identities of the neighboring cell tower(s) is used. In other words, the higher the speed, the higher the rate of change of the identities of the neighboring tower(s). At next operation 230, a speed estimate is determined based on the information regarding cellular network signals. Various statistical techniques may be utilized to derive a probabilistic speed estimate. In one embodiment described herein, a pre-trained statistical classifier based on a Gaussian Mixture Model (GMM) is used and the speed estimate provides whether the speed is most likely to be less than 10 miles per hour or greater than 10 miles per hour. The statistical technique used does not limit the invention. Other statistical techniques, such as linear regression, may also be sued. At next operation 240, a motion context classification is determined based on a combination of the data received from the at least one low-power sensor and the speed estimate. For example, in the embodiment described above where the at least one low-power sensor is accelerometer 140, when the acceleration is zero or close to zero and the speed estimate is that the speed is most likely to be less than 10 miles per hour, device 100 is most likely to be stationary, and the motion context classification is determined accordingly. In other words, information relating to a small acceleration and a small speed estimate may be combined to derive a motion context classification of being stationary. When the acceleration is characteristic of walking/running activities and the speed estimate is that the speed is most likely to be less than 10 miles per hour, the example device 100 is most likely being carried by a walking/running user, and the motion context classification is determined accordingly. When the speed estimate is that the speed is most likely to be greater than 10 miles per hour, device 100 is most likely being moved in a vehicle, and the motion context classification is determined accordingly. In summary, a motion classification may be determined probabilistically based on a combination of an accelerometer reading and a speed estimate.

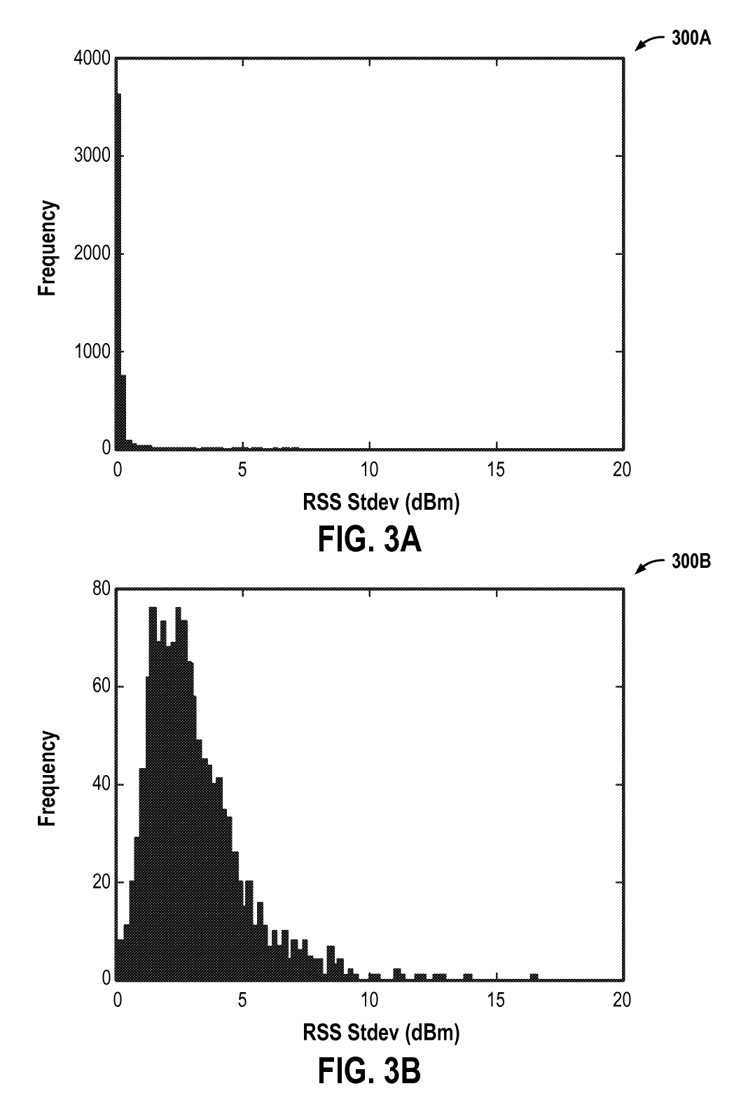

FIG. 3A is a histogram 300A of the standard deviation of example RSSIs of an example serving cell tower observed at an example stationary device 100. FIG. 3B is a histogram 300B of the standard deviation of example RSSIs of example serving cell towers observed at an example device 100 being moved at a non-negligible speed. A statistical classifier, such as a Gaussian Mixture Model (GMM) classifier, may be trained and established to probabilistically classify such information collected from an example modem 117. In one embodiment, an example statistical classifier can classify with sufficient reliability whether provided RSSIs of serving cell tower(s) correspond to a speed greater than 10 miles per hour or less than 10 miles per hour. It should be noted that the invention is not so limited, and the speed threshold implemented with the statistical classifier may be a speed other than 10 miles per hour. It should be appreciated that statistical techniques other than GMM, such as linear regression, may also be used. In one embodiment, linear regression is utilized on multiple RSSI observations. The invention is not limited by the particular cellular network signal information or the particular statistical technique used. Any method that applies one or more suitable statistical techniques to suitable information regarding cellular network signals to derive a satisfactory speed estimate may be used with embodiments of the invention. By way of example but not limitation, as described above, the higher the speed, the higher the rate of change of the identities of the serving cell(s), the higher the rate of change of the identities of the neighboring cell(s), and the higher the rate of change of RSSIs.

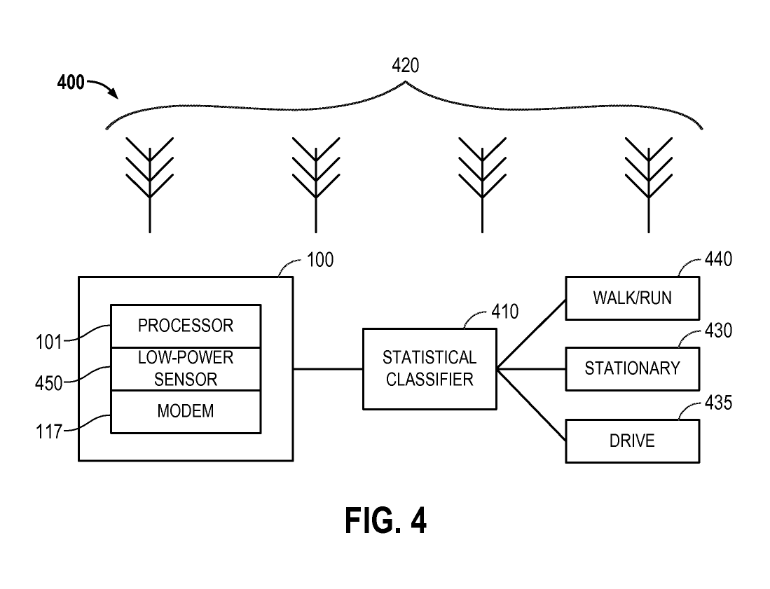

An example of the previously described embodiment can be seen with reference to FIG. 4. As can be seen in FIG. 4, within device 100, data received from at least one low-power sensor 450 is collected. The at least one low-power sensor 450 may be, for example, an accelerometer 140, a gyroscope 145, a magnetometer 150, or an ambient light sensor (ALS) 135, etc. Moreover, information regarding cellular network signals is collected from modem 117. The information regarding cellular network signals may be any combination of RSSIs and/or IDs of neighboring cell towers 420 and/or serving cell tower(s) 420. In one embodiment described herein, only RSSIs of serving cell tower(s) 420 are used. A speed estimate may be determined based on the information regarding cellular network signals using a statistical classifier 410. Various statistical techniques may be utilized in the implementation of the statistical classifier 410 to derive a probabilistic speed estimate. In one embodiment described herein, a pre-trained statistical classifier based on a Gaussian Mixture Model (GMM) is used and the speed estimate provides whether the speed is most likely to be less than 10 miles per hour or greater than 10 miles per hour. A motion context classification may be determined based on a combination of the collected data received from the at least one low-power sensor 450 and the speed estimate as determined by the statistical classifier 410. For example, in the embodiment describe above where the at least one low-power sensor 450 is accelerometer 140, when the acceleration is zero or close to zero and the speed estimate is that the speed is most likely to be less than 10 miles per hour, device 100 is most likely to be stationary, and the motion context classification is determined accordingly as stationary 430. When the acceleration is characteristic of walking/running activities and the speed estimate is that the speed is most likely to be less than 10 miles per hour, device 100 is most likely being carried by a walking/running user, and the motion context classification is determined accordingly as walk/run 440. When the speed estimate is that the speed is most likely to be greater than 10 miles per hour, the example device 100 is most likely being moved in a vehicle regardless of the acceleration, and the motion context classification is determined accordingly as drive 435.

Combining data gathered from one or more low-power sensors with a speed estimate obtained with the method described herein can generally yield more reliable motion context classifications. For example, one embodiment described herein enables better capabilities to distinguish between a stationary mobile device and a mobile device being moved in a vehicle at a constant speed. As explained above, because a stationary mobile device and a mobile device being moved in a vehicle at a constant speed both experience little or no acceleration, it may be difficult to determine the correct motion context classification based solely on the accelerometer data. Reliably distinguishing between the two motion contexts becomes possible with a sufficiently accurate speed estimate obtained using techniques described herein.

It should be appreciated that aspects of the invention previously described may be implemented in conjunction with the execution of instructions (e.g., applications) by processor 101 of device 100, as previously described. Particularly, circuitry of the device, including but not limited to processor, may operate under the control of an application, program, routine, or the execution of instructions to execute methods or processes in accordance with embodiments of the invention (e.g., the processes of FIGS. 2-4). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

It should be appreciated that when the device is a mobile or wireless device that it may communicate via one or more wireless communication links through a wireless network that are based on or otherwise support any suitable wireless communication technology. For example, in some aspects computing device or server may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, 3G, LTE, LTE Advanced, 4G, and Wi-Fi. Similarly, a wireless device may support or otherwise use one or more of a variety of corresponding modulation or multiplexing schemes. A mobile wireless device may wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (PDA), a tablet, a mobile computer, a laptop computer, a tablet, an entertainment device (e.g., a music or video device), a headset (e.g., headphones, an earpiece, etc.), a head-mounted display (HMD), a wearable device, a medical device (e.g., a biometric sensor, a heart rate monitor, a pedometer, an Electrocardiography (EKG) device, etc.), a user I/O device, a computer, a server, a point-of-sale device, an entertainment device, a set-top box, or any other suitable device. These devices may have different power and data requirements and may result in different power profiles generated for each feature or set of features.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of motion classification using a combination of low-power sensor data and modem information comprising:
collecting data received from at least one low-power sensor;
collecting information regarding cellular network signals from a modem;
determining a speed estimate based on the information regarding cellular network signals; and
determining a motion context classification based on a combination of the data received from the at least one low-power sensor and the speed estimate.

2. The method of claim 1, wherein the information regarding cellular network signals includes received signal strength indicators (RSSIs) of serving cell towers.

3. The method of claim 1, wherein the information regarding cellular network signals includes cell tower identifiers of serving cell towers.

4. The method of claim 1, wherein the determining of the speed estimate further includes utilizing a statistical classifier.

5. The method of claim 4, wherein the statistical classifier utilizes a rate of change of the information regarding cellular network signals.

6. The method of claim 4, wherein the determining of the speed estimate further includes estimating whether the speed is above or below a threshold.

7. The method of claim 4, wherein the statistical classifier is based on a Gaussian Mixture Model (GMM).

8. The method of claim 1, wherein the determining of the motion context classification includes distinguishing between two motion contexts that have similar acceleration characteristics but different speeds.

9. The method of claim 1, wherein the at least one low-power sensor includes at least one of an accelerometer, a gyroscope, a magnetometer, a microphone, a camera, a compass, or an ambient light sensor (ALS).

10. A non-transitory computer-readable medium including code which, when executed by a processor, causes the processor to perform a method comprising:
collecting data received from at least one low-power sensor;
collecting information regarding cellular network signals from a modem;
determining a speed estimate based on the information regarding cellular network signals; and
determining a motion context classification based on a combination of the data received from the at least one low-power sensor and the speed estimate.

11. The non-transitory computer-readable medium of claim 10, wherein the information regarding cellular network signals includes received signal strength indicators (RSSIs) of serving cell towers.

12. The non-transitory computer-readable medium of claim 10, wherein the information regarding cellular network signals includes cell tower identifiers of serving cell towers.

13. The non-transitory computer-readable medium of claim 10, wherein the code for determining the speed estimate further includes code for utilizing a statistical classifier.

14. The non-transitory computer-readable medium of claim 4, wherein the statistical classifier utilizes a rate of change of the information regarding cellular network signals.

15. The non-transitory computer-readable medium of claim 13, wherein the code for determining the speed estimate further includes code for estimating whether the speed is above or below a threshold.

16. The non-transitory computer-readable medium of claim 13, wherein the statistical classifier is based on a Gaussian Mixture Model (GMM).

17. The non-transitory computer-readable medium of claim 10, wherein the code for determining the motion context classification further includes code for distinguishing between two motion contexts that have similar acceleration characteristics but different speeds.

18. The non-transitory computer-readable medium of claim 10, wherein the at least one low-power sensor includes at least one of an accelerometer, a gyroscope, a magnetometer, a microphone, a camera, a compass, or an ambient light sensor (ALS).

19. An apparatus for motion classification using a combination of low-power sensor data and modem information comprising:
a memory; and
a processor configured to:
collect data received from at least one low-power sensor,
collecting information regarding cellular network signals from a modem,
determining a speed estimate based on the information regarding cellular network signals, and
determining a motion context classification based on a combination of the data received from the at least one low-power sensor and the speed estimate.

20. The apparatus of claim 19, wherein the information regarding cellular network signals includes received signal strength indicators (RSSIs) of serving cell towers.

21. The apparatus of claim 19, wherein the information regarding cellular network signals includes cell tower identifiers of serving cell towers.

22. The apparatus of claim 19, wherein the processor configured to determine the speed estimate is further configured to utilize a statistical classifier.

23. The apparatus of claim 22, wherein the statistical classifier utilizes a rate of change of the information regarding cellular network signals.

24. The apparatus of claim 22, wherein the processor configured to determine the speed estimate is further configured to estimate whether the speed is above or below a threshold.

25. The apparatus of claim 22, wherein the statistical classifier is based on a Gaussian Mixture Model (GMM).

26. The apparatus of claim 19, wherein the processor configured to determine the motion context classification is further configured to distinguish between two motion contexts that have similar acceleration characteristics but different speeds.

27. The apparatus of claim 19, wherein the at least one low-power sensor includes at least one of an accelerometer, a gyroscope, a magnetometer, a microphone, a camera, a compass, or an ambient light sensor (ALS).

28. An apparatus for motion classification using a combination of low-power sensor data and modem information comprising:
means for collecting data received from at least one low-power sensor;
means for collecting information regarding cellular network signals from a modem;
means for determining a speed estimate based on the information regarding cellular network signals; and
means for determining a motion context classification based on a combination of the data received from the at least one low-power sensor and the speed estimate.

29. The apparatus of claim 28, wherein the information regarding cellular network signals includes received signal strength indicators (RSSIs) of serving cell towers.

30. The apparatus of claim 28, wherein the information regarding cellular network signals includes cell tower identifiers of serving cell towers.

31. The apparatus of claim 28, wherein the means for determining the speed estimate further includes means for utilizing a statistical classifier.

32. The apparatus of claim 31, wherein the statistical classifier utilizes a rate of change of the information regarding cellular network signals.

33. The apparatus of claim 31, wherein the means for determining the speed estimate further includes means for estimating whether the speed is above or below a threshold.

34. The apparatus of claim 31, wherein the statistical classifier is based on a Gaussian Mixture Model (GMM).

35. The apparatus of claim 28, wherein the means for determining the motion context classification further includes means for distinguishing between two motion contexts that have similar acceleration characteristics but different speeds.

36. The apparatus of claim 28, wherein the at least one low-power sensor includes at least one of an accelerometer, a gyroscope, a magnetometer, a microphone, a camera, a compass, or an ambient light sensor (ALS).
